(19) United States
(12) Patent Application Publication
(10) Pub. No.: US 2003/0126301 A1
(43) Pub. Date: Jul. 3, 2003

(54) Machine, process and manufacture for synchronizing data across integrated applications

(76) Inventors: Jeff Mason, Wantage, NJ (US); Venkata Gandra, Edison, NJ (US); Robert Chin, Mendham, NJ (US); Barbara Chin, Mendham, NJ (US)

Correspondence Address: GOODWIN PROCTER L.L.P, 7 BECKER FARM RD, ROSELAND, NJ, 07068, US

(21) Appl. No.: 10/039,981

(22) Filed: Dec. 31, 2001

(51) Int. Cl. G06F 12/00; G06F 17/30; G06F 9/00; G06F 9/54; G06F 15/163

(52) U.S. Cl. 709/310; 707/203

(57) ABSTRACT

There is provided an apparatus, method and article of manufacture for integrating a plurality of applications using a common integration architecture wherein said apparatus, method and article of manufacture employs a Links Table for associating related data thus obviating the need to search cumbersome data stores of integrated applications for pertinent information during synchronization.

### CLAIM OF PRIORITY/CROSS REFERENCE OF RELATED APPLICATION(S)

Not applicable

### STATEMENT REGARDING FEDERALLY SPONSORED RESEARCH OR DEVELOPMENT

Not applicable.

### REFERENCE OF AN APPENDIX

Appendices A-B are contained herein. A portion of the disclosure of this patent document may contain material, which is subject to copyright/trademark protection. The copyright/trademark owner has no objection to the facsimile reproduction by anyone of the patent document or the patent disclosure, as it appears in the Patent and Trademark Office patent file or records, but otherwise reserves all copyright/trademark rights whatsoever.

### BACKGROUND

1. Field of the Invention

The present invention relates generally to data processing and more particularly, to a novel machine, process and manufacture for synchronizing data across a plurality of integrated applications.

2. Description of Related Art

Application integration is the process of bringing data or a function from one application program together with that of another application program. Implementing application integration has previously been a tedious process involving long development and programming hours. However, the current trend is to use specialized integration products (prepackaged “middleware” solutions), such as message brokers and applications servers, to provide a common connecting point among disparate applications.

Several patents and publications disclose various application integration methods, portions of which are briefly summarized as follows:

U.S. Pat. No. 6,236,994 entitled “Method and apparatus for the integration of information and knowledge,” issued on May 22, 2001 to Swartz, et al., and discloses a method and apparatus for “integrating the operation of various independent software applications directed to the management of information within an enterprise. The system architecture is, however, an expandable architecture, with built-in knowledge integration features that facilitate the monitoring of information flow into, out of, and between the integrated information management applications so as to assimilate knowledge information and facilitate the control of such information. Also included are additional tools which, using the knowledge information enable the more efficient use of the knowledge within an enterprise, including the ability to develop a context for and visualization of such knowledge.”

U.S. Pat. No. 6,256,676 entitled, “Agent-adapter architecture for use in enterprise application integration systems,” issued on Jul. 3, 2001 to Taylor, et al., and discloses “an agent-adapter architecture used in systems and methods to integrate applications of the type normally deployed across a networked enterprise. A plurality of adapters, each of which is adapted to perform a discrete function associated with respective ones of the plurality of enterprise applications is encapsulated by an agent. The agent is extensible, including one or more embedded objects, each of which is adapted to perform a discrete function that may or may not be associated with respective ones of the plurality of enterprise applications.”

Enterprise Application Integration, A Wiley Tech Brief by Willam A. Ruh et al, Wiley Computer Publishing, 2001, describes various technologies, architectures and approaches currently available for application integration.

Finally several integrated-related Internet resources such as the “EAI Journal,” www.eaiijournal.com and the “EAI Forum,” www.eaiforum.com, describe the current state of application integration technologies.

### SUMMARY OF THE INVENTION

One of several objects of the present invention (sometimes referred to as PDX) is to provide user-driven, on-demand integration of applications, particularly primarily stand-alone applications.

Further objects of the present invention include, but are not limited to: 1) providing a link to a “vertical” integration mechanism to enable the horizontally integrated applications to integrate with other platform resources, such as mainframes and servers (Unix and NT), 2) streamlining workflows, 3) eliminating redundant data, 4) move data among integrated applications with minimal effort, 5) linking data records and synchronizing linked data records across applications, 6) providing a migration path to a future state, and 7) minimizing data required by applications.

Therefore in accordance with one aspect of the present invention, there is generally provided an apparatus, method and article of manufacture for integrating a plurality of heterogeneous applications using a common integration architecture wherein said apparatus, method and article of manufacture employs a Links Table for associating related data. Utilization of the Links Table enhances processing time over those techniques that search cumbersome data stores of integrated applications for relevant information during synchronization.

The above-mentioned aspect(s) and other aspects, objects, features and advantages of the present invention will become better understood with regard to the following description, appended claims, and accompanying drawings.

### BRIEF DESCRIPTION OF THE DRAWING(S)

Referring briefly to the drawings, embodiments of the present invention will be described with reference to the accompanying drawings in which:

FIG. 1 is a general representation of various components that comprise an integration architecture constructed in accordance with the teachings herein;

FIG. 2 depicts an exemplary message structure in accordance with the teachings herein;

FIG. 3 depicts an exemplary user interface in accordance with the teachings herein;

FIG. 4 depicts an exemplary synchronization flow in accordance with the teachings herein;

FIGS. 5-10 each depict a detail of the flow set forth in FIG. 4;

FIG. 11 depicts a Links Table in accordance with the teachings herein.

FIGS. 12-16 depict exemplary application flows in accordance with the teachings herein.

FIGS. 17-22 are representations of user interface screens depicting aspects of the present invention.

### DETAILED DESCRIPTION

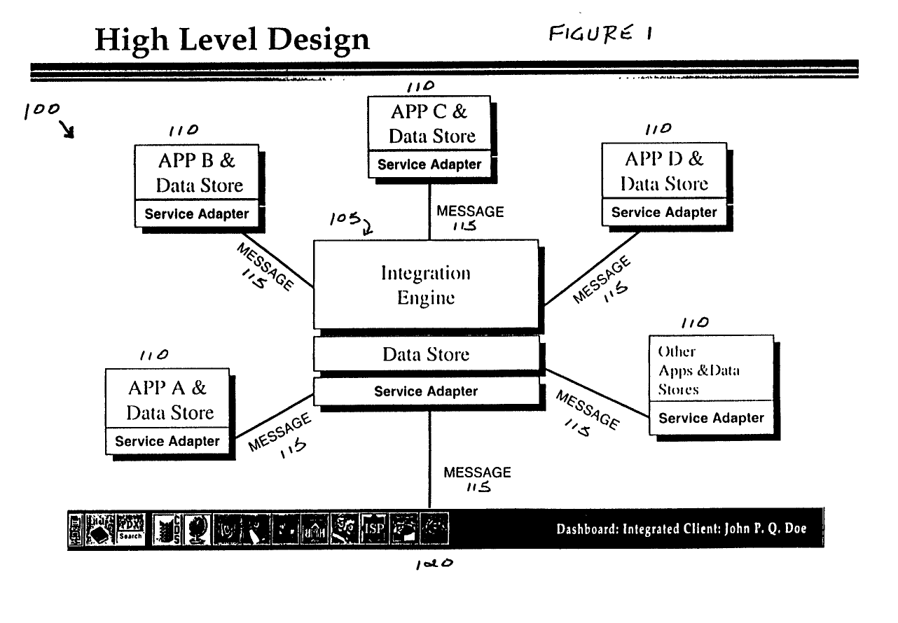

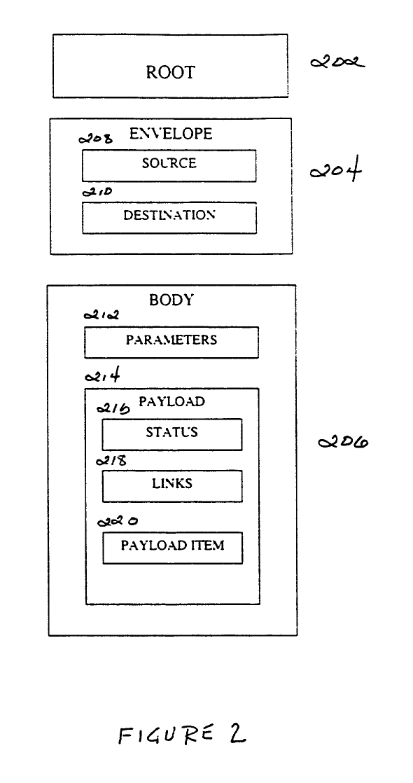

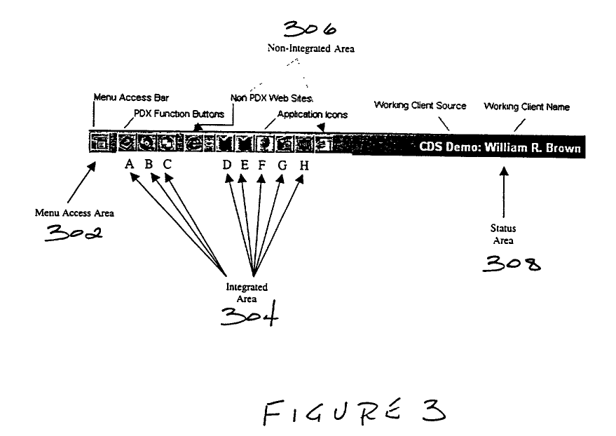

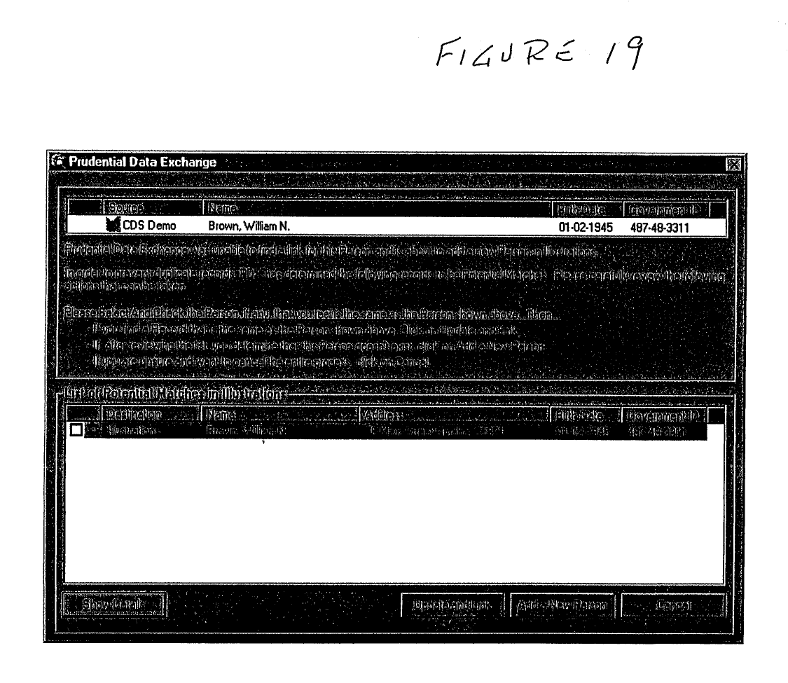

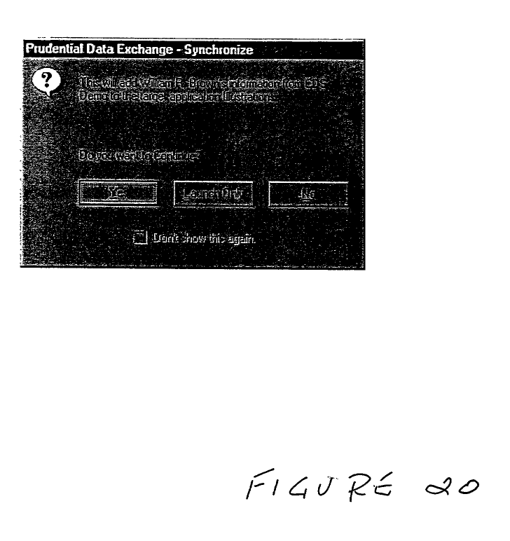

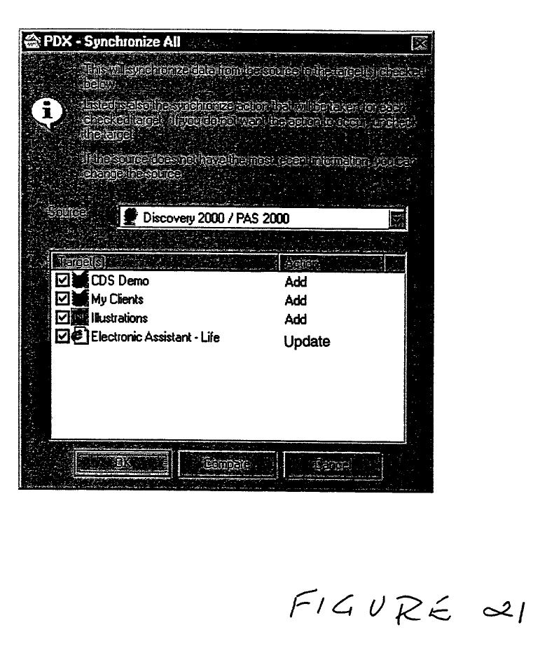

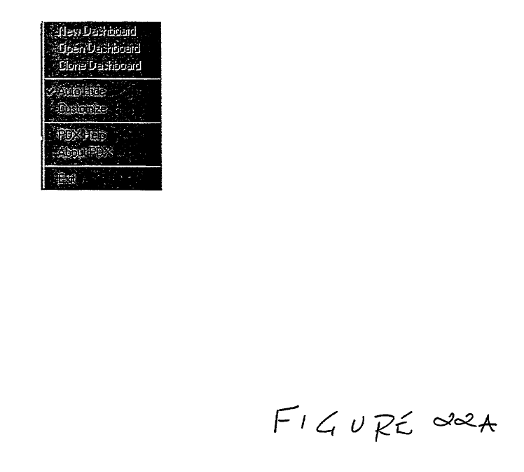

Referring more specifically to the drawings, for illustrative purposes the present invention is embodied in the system configuration, method of operation and product or computer-readable medium, such as floppy disks, conventional hard disks, CD-ROMS, Flash ROMS, nonvolatile ROM, RAM and any other equivalent computer memory device, generally shown in FIGS. 1-22. It will be appreciated that the system, method of operation and product may vary as to the details of its configuration and operation without departing from the basic concepts disclosed herein.

### GLOSSARY

In describing the present invention, the following terms are used herein.

“Data store” is a place where information is saved, preferably, in a persistent manner (e.g. on a hard drive). It may include relational databases, flat files, and proprietary storage formats.

“Horizontal integration” is integration across a single platform as opposed to integration between different platforms (e.g. client and server).

Integration software refers to the software/components used to synchronize information between applications.

“IOD” or “Integration on demand” is a user-driven approach to integration and not an automated replication model.

Vertical integration is integration between two or more platforms.

Working Client is that person whose information is designated as the current working set for any particular application and may not necessarily be a “client” of the enterprise as that term is used herein.

### INTEGRATED ARCHITECTURE

To facilitate the integration and synchronization of required information, aspects and features of the present invention are embodied in a common integrated architecture. FIG. 1, illustrates on example of such an integrated architecture 100 constructed in accordance with the teachings presented herein. As shown, the integrated architecture comprises several interrelated components, namely an Integration Engine having an Integration Engine Service Adapter and an Integration Engine Data Store associated therewith (collectively enumerated as 105), a plurality of Applications having associated Application Service Adapters and Application Data Stores (collectively enumerated as 110), Messages 115 having a predefined syntax, and a Dashboard user interface 120, all arranged in a logical hub-and-spoke configuration.

Together the Integration Engine, its Service Adapter and Data Store, function as the “hub” of the architecture. Responsibilities of the integration engine include routing messages between service adapters based on type or content, transforming a message or message content based on the requirements of the integrated applications, and controlling the flow of information between service adapters.

The predefined Messages form the spokes. The content of every Message conforms to a standard syntax. All applications/resources produce and consume Messages that conform to a standard syntax, thus the present solution supports “plug-and-play” capabilities.

Finally, the Applications and the Application Service Adapters are the ends of the spokes. Depending on a particular task, Application Service Adapters can either serve as sources or as destinations and are responsible for accessing applications/resources to retrieve requested information and transforming this information into a common syntax and back again to its original format.

Attention now turns to details of the aforementioned components.

### INTEGRATION ENGINE

The Integration Engine, its Service Adapter and Data Store are situated at center of the architecture. Together, these integration components implement intelligent messaging by triggering and executing integration flows to process events and rules that evaluate, modify, and route event data. Specific responsibilities include setting application definitions for integrated applications, setting Dashboard's settings, and implementing updates and/or additions to the Links Table (see below).

The Integration Engine's Service Adapter can be called directly from the Dashboard or the integration flows.

The design specification for the Integration Engine Service Adapter is set forth as Appendix B.

### APPLICATION SERVICE ADAPTERS

An adapter is an access point (logic) logic that provides access to the application in a structured manner. Thus, an adapter is an interface into the application that defines the requests the receiver will accept while hiding the underlying complexity of accomplishing the integration.

The Application Service Adapters herein are built to be plug and play with the system. That is to say, a new Application Service Adapter can be plugged in and removed from the architecture without impacting the remaining Application Service Adapters.

Each application has its own data requirements. Typically, data requirements will not match from application to application. Therefore, it is the responsibility of the Application Service Adapter to understand and provide services to its underlying data store and further perform the necessary business logic to the data being passed to or retrieved from it.

While all Application Service Adapters speak in a standard syntax, nonetheless should an application require another standard, it can easily be supported by the transformation capabilities of the Integration Engine. To that end, the Integration Engine communicates with the Application Service Adapters via predefined Messages (see below).

The design specification for an Application Service Adapter is set forth as Appendix C.

### MESSAGES

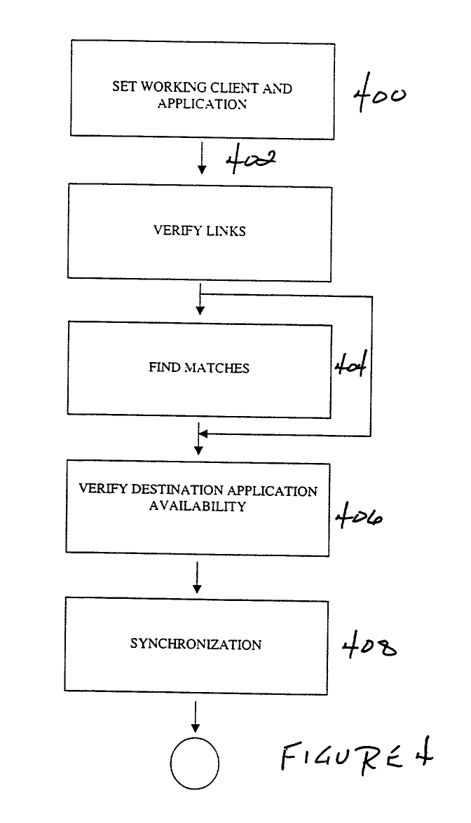

The predefined Messages recognized by the present invention form the spokes in the integrated architecture. In FIG. 3, for visual simplicity, the spokes also include the technology transport of the messages. The content of every Message conforms to a standard syntax. Specifically, the structure of the Messages created and processed in the present invention may be logically divided into three main sections, a Message Root section 202, a Message Envelope section 204 and a Message Body section 206. The Message Envelope section is further divided into a Source section 208 and a Destination section 210. The Message Body section is further divided a Parameters section 212 and a Payload section 214. The Payload section is still further divided into a Status section 216, a Links section 218, and a Pay Load Item section 220. Each of the foregoing sections and subsections will now be further explained below.

1. Message Root

The Message Root section contains header information about a given message.

The Message Root comprises an IONS identifier (IONSID) field and a message request type (RequestType) field. A description of each of the foregoing fields follow.

| Property | Description |
|---|---|
| IONSID | A unique identifier for a user, e.g., the |
| | user's Windows ® operating system login |
| | id. |
| RequestType | The name/type of the request message, e.g., |
| | GetPerson_RQ message or SyncPerson_RQ |
| | message. See Appendix A for additional message |
| | types. |

The Message Envelope section comprises a Source section and a Destination section containing routing information, which lets the Integration Engine know which Service Adapter(s) to send the message to. In cases where source information is not needed, the initiator of the message need not supply source information.

Note: in order to maintain the principle that a user should have exactly the same rights to the information in an application data store that they have when using the application itself, we must maintain information about users.

A. Source

The Source section consists of several fields having information pertaining to the Service Adapter of the Source Application. The relevant fields are described below.

| Property | Description |
|---|---|
| DataSourceDescription | A description of the data source, usually the |
| | ODBC DSN or a File Name. |
| Name | The name of the Service Adapter. |
| UserID | An application user |
| | identifier. Note: This is not the IONSID |
| | mentioned above. |
| Password | An application user password associated |
| | with the UserID. The password is used to |
| | validate an applications settings when a user |
| | customizes the Dashboard. There is no |
| | requirement to store the password. |

B. Destination

The Destination section consists of several fields having information pertaining to the Service Adapter of the Destination Application. The relevant fields are similar to that of the Source section and are described below.

| Property | Description |
|---|---|
| DataSourceDescription | A description of the data source, |
| | usually the ODBC DSN or a File Name. |
| Name | The name of the Service Adapter. |
| UserID | An application user |
| | identifier. Note: This is not the IONSID |
| | mentioned above. |
| Password | An application user password associated |
| | with the UserID. The password is used to |
| | validate an applications settings when a user |
| | customizes the Dashboard. There is no |
| | requirement to store the password. |

3. Message Body

The Message Body section contains information to enable a receiver of the message to process a request and further holds the requested information or data. As described earlier, the Message Body is divided into two sections—Parameters and Payload. A description the these sections follows.

A. Parameters

The Parameters section contains the parameters that a message requires. In cases where a message does not utilize a parameter this section will be blank. The Parameters section comprises two fields, which are described below.

| Property | Description |
|---|---|
| Name | The name of the parameter |
| Value | The value of the parameter. |

B. Payload

The Payload section contains the results of the message request. The Payload section divides into three sub-sections, namely a Status section, a Links section and a Payload Items section. The foregoing sub-sections are described below.

i. Status

The Status section contains information related to the completion of the message. If the message is successful, it will contain a status code and description indicating success. It is also here that you will find information about any errors that were encountered during the messages execution. There can be many occurrences of this section. The Status section comprises several fields, each of which are described below.

| Property | Description |
|---|---|
| StatusCode | The status code of the error. |
| Description | A description of the error. |
| OriginatedFrom | The name of the dynamic link library (DLL) that the |
| | error occurred in. |
| ModuleName | The name of the module that the error occurred in. |
| MethodName | The name of the method where the error occurred. |

ii. Links

The Links section is utilized during synchronization. Among other information, the Links section contains a record of a Service Adapter's actions, that is whether an “Add” or “Update” was done. In addition, it contains certain information a Service Adapter needs during processing, for example, the unique identifiers assigned to the Source and Destination Applications. The Links section comprises several fields, each of which are described below.

| Property | Description |
|---|---|
| DataSourceDescription | A description of a data source, usually the |
| | ODBC DSN or a File Name |
| Name | The Service Adapter's name |
| *SourceID | A unique identifier for the object, e.g. a |
| | person or an organization, in the |
| | Source Application |
| *DestinationID | A unique identifier for the object in the |
| | Destination Application. |
| *PartyID | A unique identifier for the object within |
| | the system. |
| *ObjectType | Identifies the object as a person or an |
| | organization. |
| *ActionPerformed | The action that the Service Adapter |
| | performed on the object, e.g., “Add” or |
| | “Update” |

*These properties can occur multiple times.

iii. Payload Item

The Payload Item section contains the results of a request. For example, a receiver of a Search_RQ request message would place the search results in the Payload Item section of a response message. There can be one or more instances of a payload item. Since a request can be sent to multiple destinations, to track what part, or “item”, in the payload came from a particular Service Adapter the following properties/fields are included at the beginning of each Payload Item section.

| Property | Description |
|---|---|
| DataSourceDescription | The description of a data source. Usually the |
| | ODBC DSN or a File Name. |
| Name | The Name of the Service Adapter |

The rest of Payload Item section varies based on the request. Specific message types used herein are set forth in the Appendices.

### USER INTERFACE

The present system includes a graphical user interface that enables a user to work with the aforementioned integration flows.

Accordingly, FIG. 3 depicts an exemplary embodiment of an “Integrated Client Dashboard” graphical user interface (“Dashboard”) utilized in the present invention. The Dashboard is designed to facilitate user-driven data integration across integration Applications via a flexible application workflow model.

For example and referring to the insurance industry, a user who starts the sales process by entering information in a prospecting application (CDS) and then moves on to discovery and analysis using a discovery application (DIS) and an analysis application (PAS) can use the Dashboard to move client information from the CDS to DIS/PAS applications by activating the buttons on the Dashboard. Similarly, an alternative workflow is also supported wherein a user begins prospecting by enter information into illustrations application (ISP) and then moves to the discovery application.

As shown, the look and feel of the illustrated embodiment of the Dashboard is based on the look and feel of the popular Shortcut Bar used in Microsoft® Office suite. The Dashboard spans the length of the display device and is initially situated at the bottom of the display medium, such as a window object or computer screen. However, as is conventional, the Dashboard may be resized and also positioned elsewhere on the display device as preferences dictates.

The Dashboard includes several areas, namely a Menu Access area 302, an Integration area 304, a Non-Integrated area 306, and a Status area 308, which together invoke aspects and features of the present invention. The details of each of these areas will now be discussed.

Menu Access Area

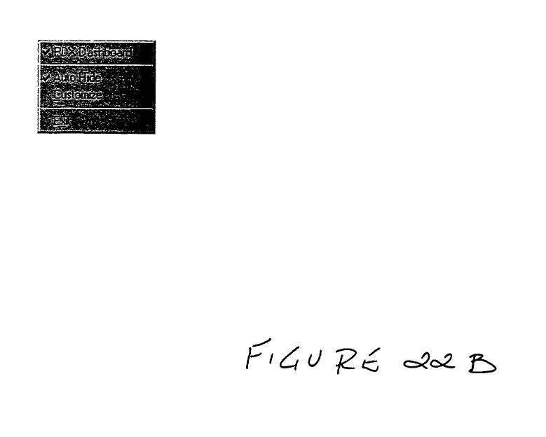

The Menu access area comprises a Menu Access button. Upon selection of the Menu access button a menu bar appears like that shown in FIG. 22. As indicated, the menu bar provides access to certain commands/functions, for example, Auto Hide, Customize, Help and Exit, that control certain aspects of the instant invention. The Auto Hide command enables the Dashboard to reside behind other applications displayed on the display device. The Customize command allows the user to alter settings for the Dashboard, for example, adding/removing application files to/from the Dashboard, modifying information about a particular application, and modifying other attributes of the Dashboard, including color and size.

Selecting the Help command launches the Help facility and selecting the Exit command exits the Dashboard. Other commands/function may also be displayed.

Integration Area

The Integration area is a collection of buttons that serve as shortcuts for executing and controlling the synchronization process describe herein.

For example, the embodiment shown in FIG. 3 depicts, a Help button (A), a Search button (B), a MultiSync button (C) and several buttons representing applications integrated with the present system (D-H).

Selecting the Search button launches a search applet for searching integrated applications. The search applet returns and displays results based on the search criteria entered. Using the returned results a user may take the following actions: 1) select a Working Client causing information about the Working Client to appear in Status area of the Dashboard); 2) select the Working Client and view all data relating to the Working Client, and 3) select a Working Client and launch directly to the application where the client resides.

Selecting the MultiSynch button synchronizes data from Source to Destination Applications.

Selecting any one of the integrated application buttons will process the Working Client's information in accordance with the teachings expressed herein, for example, push data from a source to the selected integrated application.

Non-Integrated Area

The non-integrated area includes a non-integrated application button and one or more specific application/website buttons. Upon selection of the non-integrated application button, a drop down list appears. The drop down list sets forth at least all external, non-integrated applications/web sites having buttons appearing on the Dashboard. Selecting any one of the application/website buttons will launch the particular application/website.

Status Area

The Status area displays information that is relevant to the current Working Client, for example, the name of and the Working Application containing the Working Client.

When the Dashboard restarts, it will retain all prior settings at shut down including the Working Client and Working Application information and the Dashboard's last position on the display device

Other Features/Embodiments of the Dashboard

The Dashboard, in its most basic embodiment, may be customized to only consist of a Menu Access area, an Integration area and a Status Area and yet still retain the desired functionality.

In alternative embodiments of the Dashboard, certain areas of the Dashboard will display hover text indicating the function of the area. For example, to display the function of the Multi Sync button, a user positions the mouse over the button for a few moments to generate a hover text stating “Send Working Client to Multiple Applications.”

Further, when a user right-mouse-button clicks anywhere on the Dashboard, the system displays a shorter, modified menu bar. This menu has three of the same functions as the regular menu—Auto Hide, Customize, and Exit. These behave exactly the same as on the regular menu.

### DATA SYNCHRONIZATION

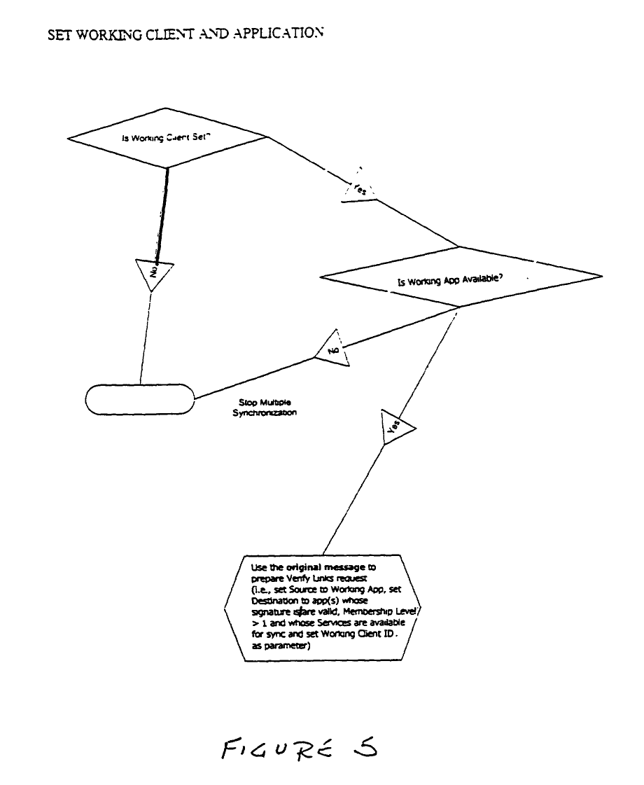

An application of the present solution will now be described with reference to FIGS. 4-11. The sections that follow demonstrate how customer demographic information is modified across several integrated heterogeneous applications.

FIG. 4 depicts a high level view of an exemplary data synchronization flow in accordance with the principles expressed herein comprising several interrelated software modules, namely, a Set Working Client & Application module 400, a Verify Links module 402, a Find Matches module 404, a Verify Destination Application Availability module 406 and a Synchronization module 408.

When a user clicks on an application icon on the Dashboard signaling data synchronization, an integration request message is generated by the dashboard and sent to the Integration Engine where certain pre-processing steps are first performed before the integration request message is handled. An integration request message is a template by which all the messages described herein are derived from. The messages have a certain attributes that are the same regardless of what type of request is being made (for example, whether the request is a Search, Sync, etc.). Specifically, all messages have the following properties, IONSID, REQUEST_TYPE, SOURCE, DESTINATION, PARAMETERS.

As shown in FIG. 4, to begin synchronization, the Set Working Client & Application module executes. This module performs the pre-processing steps of verifying whether a desired Working Client has been properly selected and whether a desired Working Application (Source Application) is available for synchronization. If true, the Verify Links module 4 is dynamically created (see below) and utilized as a basis for the synchronization flow.

If the Working Client is properly set and the Source Application is available for synchronization, the Verify Links module 402 executes. This module is dynamically created and utilized as a basis for the synchronization flow. Specifically, this module first verifies that signatures exist in the Destination Application data store. For example, when a signature check is performed, a getSignature message is constructed and sent to a Destination Application's Service Adapter. Next, an attempt to retrieve the links for the Working Client in both the Source and Destination Applications is performed against the Integration Engine's database.

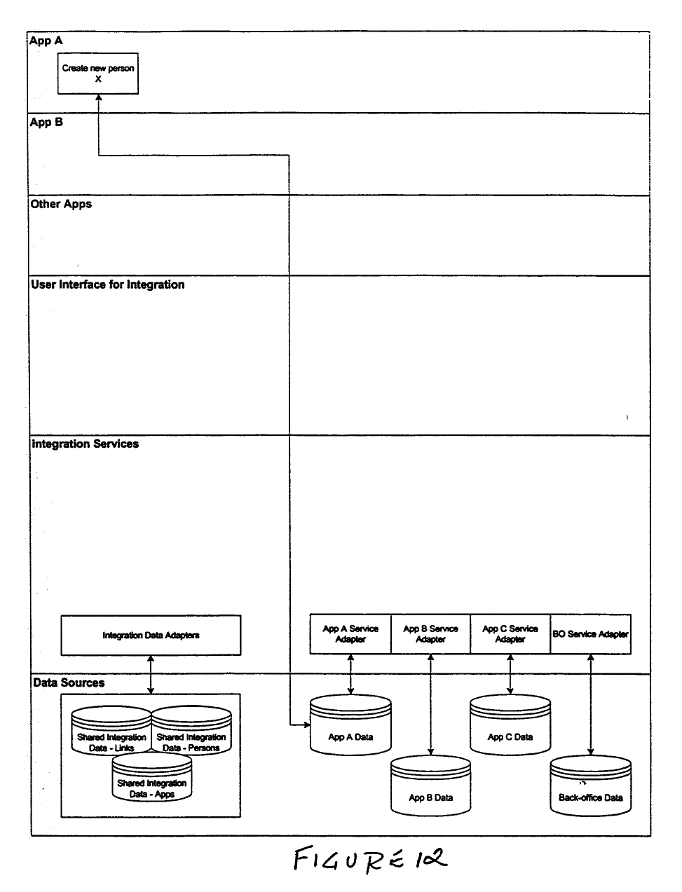

Attention will now turn to the Links Table as that data structure is used herein. A dynamic Link Table like that shown in FIG. 11 is populated whenever a user establishes links among integrated applications for a particular customer/person/client. As shown, the Link Table has five columns entitled, Link Key, User Application Id, Party Id, Client Id and Last Sync Date.

The Link Key column contains unique identifiers associated with each row in the Link Table. In the present example, each row is number sequentially. Thus, row one has a link key of 1, row 2 has a link key of 2 and so on.

The User Application Id column contains unique identifiers associated with the integrated applications. Thus, in the example illustrated in FIG. 11, the CDS application is assigned a user application id of 5, the ISP application is assigned a user application id of 6 and the PAS application is assigned a user application id of 7.

The Party Id column contains global identifiers associated with each customer/person/client in the Integration Engine data store. Thus, in the example illustrated in FIG. 11, customer/client/person William Brown is assigned a party id of 2 and customer/client/person J. Doe is assigned a party id of 2. Notably, a glance down the Party Id column immediately tells a reviewer that only two people are currently linked in the Integration Engine data store.

The Client Id column contains unique identifiers associated with customers/clients/persons in their respective native applications. Thus, in the example illustrated in FIG. 11, the CDS application assigns customer/client/person W. Brown a client id of 20 and assigns customer/client/person J. Doe a client id of 200. The PAS application assigns a client id of 20 to customer/client/person W. Brown and assigns customer/client/person J. Doe a client id of 200.

The Last Sync Date column sets forth the most recent date synchronization was done for a particular customer/clients/person. Thus, in the example illustrated in FIG. 11, data was last synchronized in the CDS application for customer/client/person W. Brown on Jan. 18, 2001 and in the ISP and PAS applications on May 22, 2001. For customer/client/person J. Doe, data was last synchronized in the CDS and PAS applications on Feb. 4, 2001.

Due to the inherent nature of technology, unforeseen glitches may occur and as a result cause an application's data to become corrupted. However, once an application's data is restored, all of the unique identifiers in the application's data store will change where the identifier is a sequentially generated one. Consequently, the identifiers will no longer match what is stored in the Link table for that application data store.

Without correction, a synchronize action will associate and overlay information with the wrong individual/object/item in the application's data store.

Because of the necessity to provide correct and consistent information, the present invention provides for the Links Table to be updated whenever a particular application's data store has been corrupted, reloaded or refreshed.

The first time an application's data store is used, a signature record should be written into the data store where the data store uses a unique identifier for an individual/item/object that will change upon a data reload (e.g. have a sequentially generated unique identifier).

The unique identifier for the signature record is recorded in the link table. On start up, a check of all signature records will be performed. If a signature record does not exist in one or more application data stores, an error message is generated display an information and warning message for each application such as “XYZ data appears to have been refreshed. Links are no longer valid. Do you want to clear all links for this application?” If a user selects “Yes”, the link table entries for that application are reset and a new signature record is written to the application data store. If “No” is instead selected, all add and update actions for that application is disabled. For example and referring to FIG. 11, if the CDS application's data store was corrupted and subsequently refreshed and a user selects Yes, all links for CDS in the Links Table, that is Rows 1 and 4, would be removed and replaced with updated information. If a user selects No the user will unable to use the CDS application button on the Dashboard for synchronization.

Referring back to FIG. 4, if no links for the Working Client in the Source and Destination Applications were found in the Verify Links module 402, the Find Matches module 404 executes. Otherwise, the Find a Match module 404 is bypassed and control passes to the Verify Destination Application Availability module 406. The Find Matches module 404 searches within data stores associated with selected Destination Applications to locate information matching that of the Working Client.

Next, the Verify Destination Application Availability module 406 executes. This module determines whether the desired Destination Application(s) is/are currently available for synchronization. If true, a SyncPerson_RQ message will be created (see below) and utilized in the Synchronization module described below.

Finally, the Synchronization module 408 executes. This module, among other things, performs the desired task of synchronizing data from the Source Application to the desired Destination Application(s).

For a better understanding of the present solution, the above modules will now be further described in the sections that follow.

Set Working Client and Application

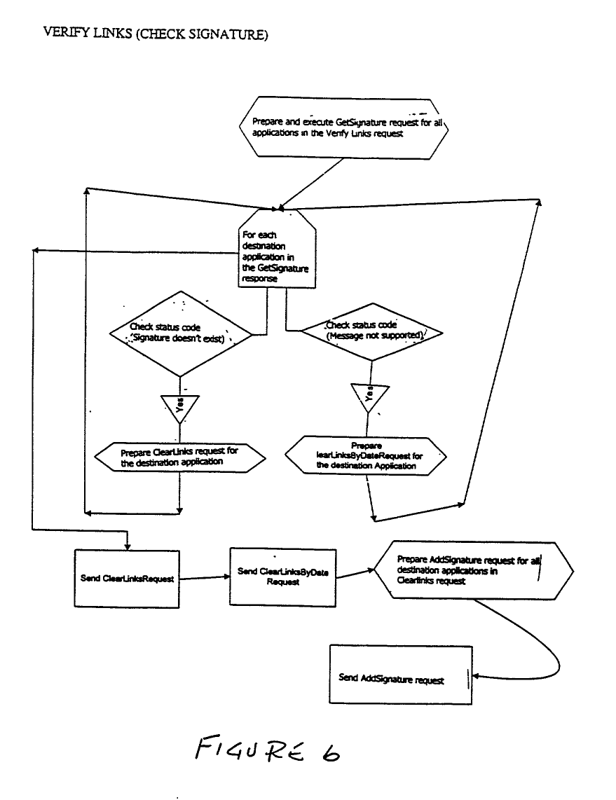

Referring to FIG. 5, there is shown an exemplary block diagram detailing an exemplary process flow of the Verification module in accordance with the principles expressed herein.

In response to an integration request message, a determination is first made as to whether the desired Working Client is set. If the Working Client is not set, execution terminates and in one embodiment of the present solution, an error message is generated indicating that the Working Client is not set. If, on the other hand, the Working Client is set than a determination is made as to whether a selected Working Application is available for data synchronization. During the synchronization process, the Working Application will serve as the Source Application. If the Source Application is not available for data synchronization, execution terminates and in one embodiment of the present solution, an error message is generated indicating that the Working Application is not available for synchronization. However, if the Working Application is available for synchronization, the Verify Links module will be dynamically constructed based upon the original integration request message.

That is to say, in preparing the Verify Links module, certain information is extracted from the original integration request message and included in the Verify Links module, but not limited to, the Working/Source Application, the Working Client, and all Destination Applications.

Finally, after the Working and Client applications have been properly verified and the Verify Links module constructed, control passes to the next module in sequence.

Verify Links

Upon completion of the Verification module, the Verify Links module executes in accordance with the following exemplary process flow.

In one embodiment of the present invention, the Verify Links module logically divides into two sub-processes. First, signatures are checked and second, links between the Working Client and Destination Applications(s) are checked in accordance with the following exemplary process flow.

A. Check Signatures in Destination Application's Data Store

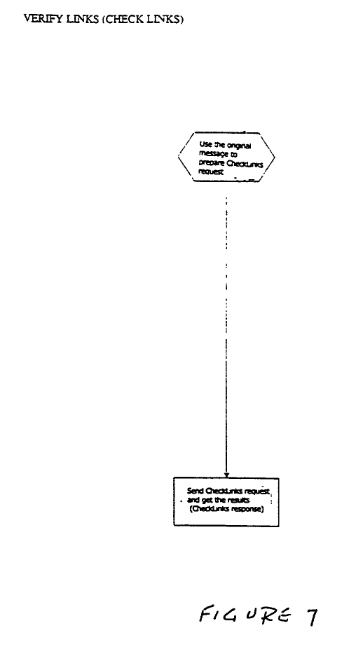

Referring to FIG. 6, first, the Integration Engine's Service Adapter constructs a GetSignature_RQ message based upon the contents of the VerifyLinks message. Specifically, the Integration Engine's Service Adapter constructs a GetSignature_RQ message for each application contained in the Source and Destination sections of the VerifyLinks message envelope and transmits the same to the Service Adapters of the Destination Application(s).

Next, in response to the GetSignature_RQ message, each Destination Application's Service Adapter determines whether a signature already exists in the Destination Application's data store and whether the Destination Application's Service Adapter supports the integration request message. In determining whether a signature exists, the Service Adapter checks the value in the Status Code section of the GetSignature_RQ message. If a signature does not exist, then the Destination Application's Service Adapter constructs a ClearLinks_RQ message for the Destination Application and execution control returns to process the next Destination Application contained in the GetSignature_RQ message. If the Service Adapter supports the integration request message, the Destination Application's Service Adapter constructs a ClearLinksByDate_RQ message for the Destination Application and execution control returns to process the next Destination Application contained in the GetSignature_RQ message.

If the Destination Application's Service Adapter supports the integration request message but the relevant signature does not exist in the Destination Application's data store, both the ClearLinks_RQ and the ClearLinksByDate_RQ messages are transmitted to the Integration Engine's Service Adapter. In response to the two messages, the Integration Engine's Service Adapter constructs an AddSignature_RQ message and transmits the message to the Destination Application contained in the ClearLinks_RQ message. In response to the AddSignature_RQ message, the Destination Application's Service Adapter will add the signature to the Destination Application's data store. The foregoing process is done for all Destination Applications wherein the Destination Application's Service Adapter supports the integration request message but the relevant signature does not exist in the Destination Application's data store.

B. Check Links Using Links Table

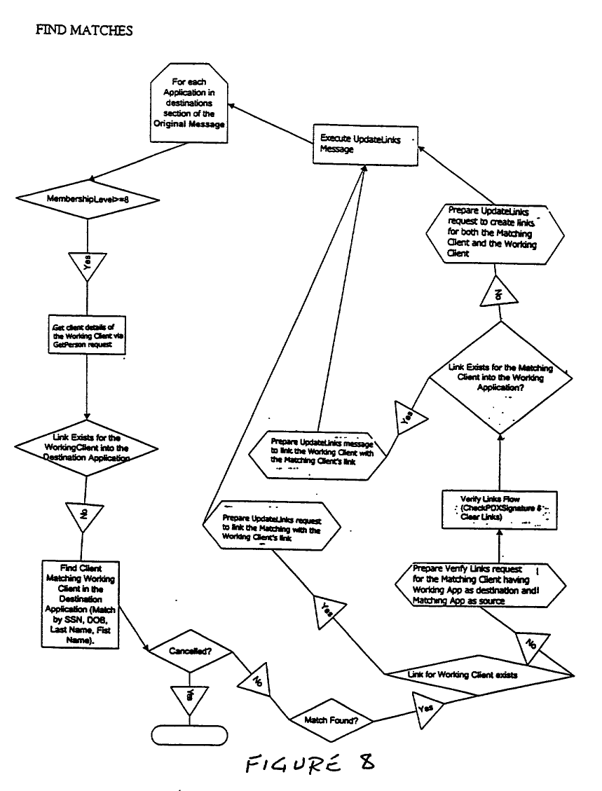

Referring to FIG. 7, after signatures have been checked, links between the Working Client and Destination Applications(s) are also checked.

First, the Integration Engine's Service Adapter constructs a CheckLinks_RQ message based upon information derived from the original integration request message and transmits the same to the Destination Applications. The CheckLinks_RQ message will check to see if a link or links for the Working Client/Person exist between the Source Application and the Destination Application.

In response to the CheckLinks_RQ message and for each Destination Application contained in the message envelope of the CheckLinks_RQ message, the Integration Engine's Service Adapter will check the Links Table to determine whether a link for the Working Client/Person exists between the Source Application and the Destination Application. A CheckLinksResponse message is then constructed and transmitted indicating the results of the query.

Find Matches

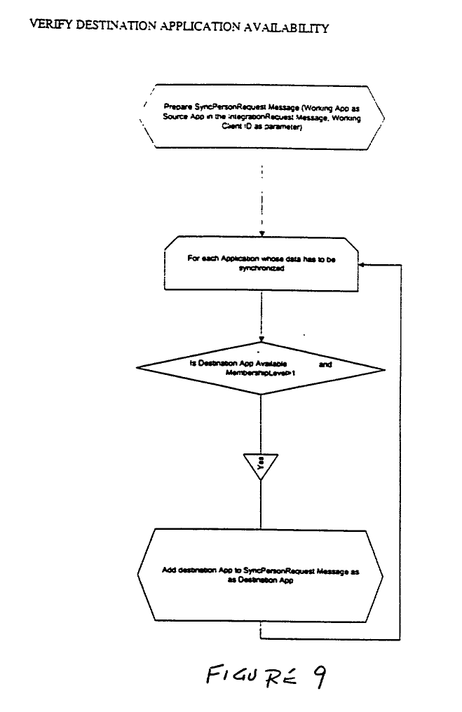

Referring to FIG. 8, the Find Matches module executes, if required, in accordance with the following exemplary process flow. Note the Find Matches module executes only if no link was found in the previous module.

For each Destination Application contained in the message envelope of the original integration message, the following steps occur:

First, the Integration Engine Service Adapter constructs and transmits a ServiceAvailable_RQ message to the Destination Application's Service Adapter to determine whether the Destination Application is available for synchronization and more particularly, whether the Destination Application's Services are available.

If the response to the ServiceAvailable_RQ message is positive (that is the Destination Application has synchronization capability), The Integration Engine Service Adapter issues a GetPersonDetails_RQ message to the Source Application's Service Adapter. In response to GetPersonDetails_RQ message, the the Source Application's Service Adapter retrieves and transmits the desired customer demographic information. If, however, the Destination Application's Services are not available, execution terminates and, in one embodiment of the present solution, an error message is generated indicating that the Destination Application is not configured for synchronization.

Next, a determination is made as to whether a link exists for the Working Client between the Source Application and the Destination Application.

If a link exists for the Working Client between the Source Application and the Destination Application, then execution control passes to the next module in sequence, namely the Determine Destination Application Availability module.

If, on the other hand, there is no link for the Working Client between the Source Application and the Destination Application, the Destination Application's Service Adapter searches the Destination Application's data store to find a potential Matching Client for the Working Client using the following exemplary search criteria: Social Security Number, Date of Birth, Last Name, and First Name. This process is done to avoid duplicate entries of the Working Client in the Destination Application's data store. Note: the Working Client may in fact exist in the Destination Application's data store but a link may not exist for the Working Client between the Source Application and the Destination Application. If there are no potential Matching Clients, execution control passes to the next module in sequence, namely the Determine Destination Application Availability module.

If one or more potential Matching Clients are found, they are displayed to the user. The user is then provided with three options.

Option 1: The user wishes to add the Person because none of the potential Matching Clients actually matches the Working Client;

Option 2: The user desires to update and link the Person because at least one of the potential Matching Clients actually matches the Working Client; or

Option 3: The user cancels and control is returned to the Dashboard.

Referring to options 1 and 2, if the user selects option 1, execution control passes to the next module in sequence. If the user selects option 2, a determination is made as to whether a link for the Working Client between the Source Application and the Destination Application exists in the Integration Engine's Database.

Outcome 1—No link For Working Client Exists in the Integration Engine's Database

If there are no links for the Working Client in the Integration Engines database, a determination is then made as to whether a link for the selected Matching Client between the Source Application and the Destination Application exists in the Integration Engine data store via the Verify Links module.

In response to the CheckLinks_RQ message, the Integration Engine's Service Adapter will check the Links Table to determine whether a link for the Matching Client exists between the Source Application and the Destination Application. A CheckLinksResponse message is then constructed and transmitted indicating the results of the query.

If a link for the selected Matching Client exists, an UpdateLinks message is constructed and executed resulting in a link being created between the Working Client in the source application and the selected Matching Client in the Destination Application. Note: Since a link already exists, the PartyID of the link for the person selected will be used when creating link. Thereafter, execution control returns to the beginning of the iterative loop to process the next Destination Application contained in the message envelope of the original integration request message.

If, on the other hand a link for the selected Matching Client does not exist in the Integration Engine data store, an UpdateLinks message is constructed and executed, resulting in a link being created between the Working Client in the

Source application and the selected Matching Client in the Destination Application. Note: Since no link existed for the Working Client or selected Matching Client, a new PartyID will be created upon completion. Thereafter, control returns to the beginning of the iterative loop to process the next Destination Application contained in the message envelope of the original integration request message.

Outcome 2—Link for the Working Client Exists

If a link for the Working Client exists in the Integration Engine data store, an UpdateLinks message is created and executed resulting in a link being created between the Working Client in the Source Application and the selected Matching Client in the Destination Application, Note: Since a link already exists, the PartyID of the link for the working client will be used when creating link. Thereafter, execution control returns to the beginning of the iterative loop to process the next Destination Application contained in the message envelope of the original integration request message.

After all Destination Applications contained in the message envelope of the original integration request message having been processed, execution control passes to the next module in sequence.

Determine Destination Application Availability

Referring to 9, upon completion of the preceding modules, the Verify Destination Application Availability module executes in accordance with the following exemplary process flow.

First, a SyncPerson_RQ message is prepared based on the original integration request message as follows: the Source Application of the SyncPerson_RQ message is set to the Source Application of the original integration request message and the Working ClientID of the original integration request message is used as a parameter of the SyncPerson_RQ message.

For each Destination in the Destinations Section of the SyncPerson_RQ message the following steps occur:

First, a determination is made as to whether the Destination Application's Services are available by issuing a ServiceAvailable_RQ Message to the Destination Application Service Adapter.

If the Destination Application's Services are available, the Destination Application is added to the message envelope (that is, the Destinations section) of the SyncPerson_RQ message. Thereafter, execution control returns to the beginning of the loop to process the next Application requiring synchronization.

If the Destination Application's Services are not available, execution terminates and, in one embodiment of the present solution, an error message is generated indicating the same.

Finally, after all Destination Applications have been added to the message envelope of the SyncPerson_RQ message, control passes to the next module in sequence.

5. Synchronization

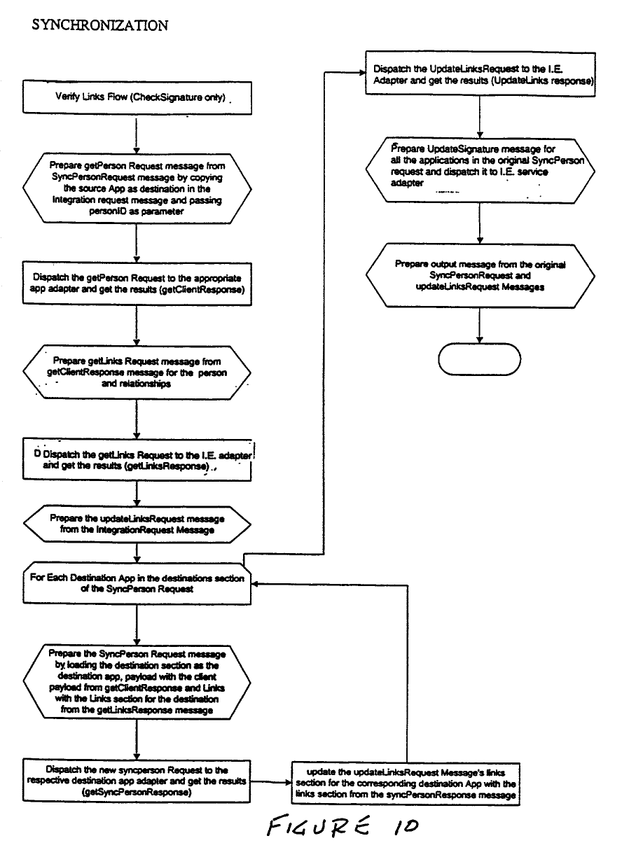

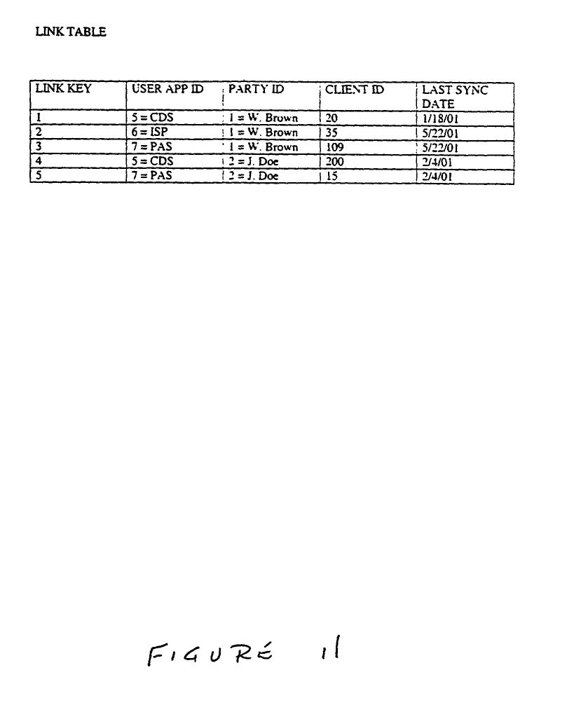

Referring to FIG. 10, after the Verify Destination Application Availability module has executed, control passes to the Synchronization module, which executes in accordance with the following exemplary process flow.

First, signatures are checked via the Verify Links module (see above).

Next, a GetPerson_RQ message is constructed based upon information derived from the SyncPerson_RQ message as follows: the Destination Application of the GetPerson_RQ message is set to the Source Application of the SyncPerson_RQ message and the PersonID parameter of the SyncPerson_RQ message is passed as a parameter of the GetPerson_RQ message.

Next, the GetPerson_RQ message is sent to the Service Adapter of the Destination Application. The Destination Application's Service Adapter retrieves the appropriate customer demographic data, constructs and transmits a reply message (GetClientResponse message) having the requested demographic data.

Next, a GetLinks_RQ message is constructed based upon information derived from the GetClientResponse message. The GetLinks_RQ message retrieves other relationships linked to the desired person, such as mother, father, son, etc.

Next, the GetLinks_RQ message is sent to the Integration Engine's Service Adapter. The Integration Engine's Service Adapter retrieves any existing linked relationships, constructs and transmits a GetLinksResponse reply message having the linked relationships

Next, an UpdateLinksRequest request message is constructed using information derived from the original integration request message. (Note: at this stage in the process, the SynchPerson_RQ message is still being prepared for execution.)

Next, for each Destination Application in the Destinations section of the SyncPerson_RQ message, the following steps occur:

Next, the SyncPerson_RQ message is further populated with the following information: the Destination Application is loaded in the Destination section of the SyncPerson_RQ message, the payload of the GetClientResponse message (having demographic information) is loaded in the Payload section of the SyncPerson_RQ message and the Links section of the GetLinksResponse message is loaded in the Links section of the SyncPerson_RQ message

Next, the SyncPerson_RQ message is sent to the Destination Application's Service Adapters. In response to the SyncPerson_RQ request, the Destination Application's Service Adapter retrieves the desired data from the data store of the Destination Application (sync data from the Source Application's data store to the Destaintion Application's data store), constructs and sends a GetSyncPersonResponse reply message indicating if the synchronization was successful or not. If an error was encountered during the processing, this error will be included in the message along with information about the error itself, such as, number description, etc.

Next, the Link section of the UpdateLinks_RQ message is updated to include the link information of the Links section of the GetSyncPersonResponse reply message.

Control returns to the beginning of the loop to process the next Destination Application in the Destinations section of the SyncPerson_RQ request message.

After all Destination Applications have been processed (synched), the UpdateLinksRequest message is sent to the Service Adapter of the Integration Engine. In response to the UpdateLinks_RQ request, the Integration Engine's Service Adapter uses the information stored in the Links section of the UpdateLinks_RQ to update the Links Table. More particularly, once synchronization is complete, the SyncPerson_RQ message will add or update the links for the Source and Destination(s) if necessary.

Thereafter, the Integration Engine's Service Adapter constructs and dispatches an UpdateLinksResponse reply message indicating whether the process was successful or not. If not, an appropriate error message will be returned.

Next, an UpdateSignature message is constructed for all applications in the Source and Destination sections of the SyncPerson_RQ message, and dispatched to the Integration Engine's Service Adapter. The Service Adapter then adds the date of the synchronization to the Links Table.

Finally, in response to the UpdateSignature message, the Integration Engine's Service Adapter constructs and dispatches an Output message based on information derived from the SyncPerson_RQ and UpdateLinks_RQ messages.

### ALTERNATIVE APPLICATION INTEGRATION FLOWS

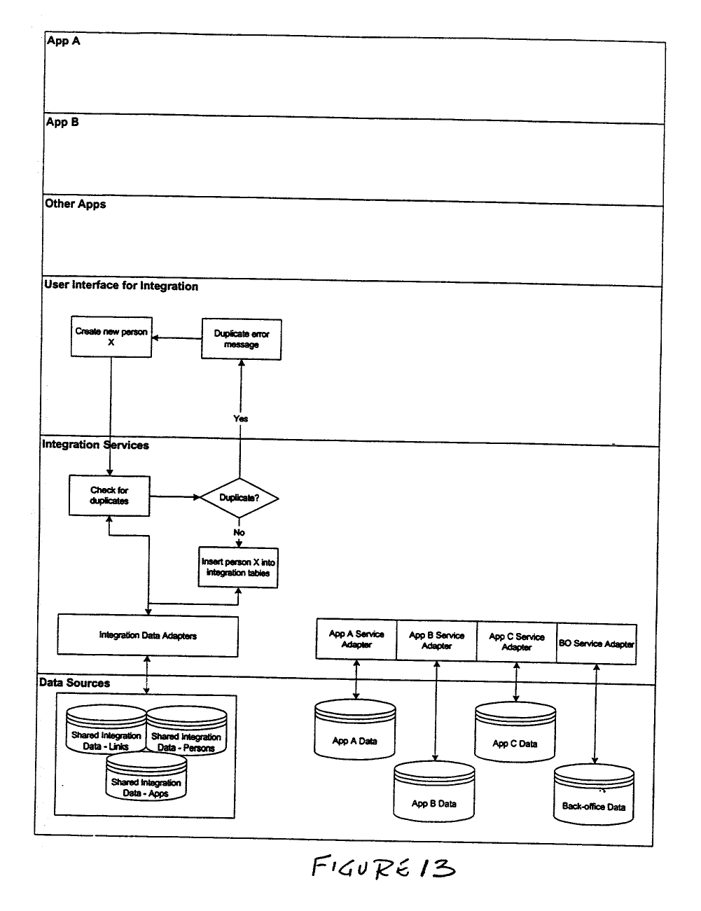

FIGS. 12-16 depict alternative integration flows associated with certain aspects of the present invention.

In each figure, the integrated software architecture is divided into levels, namely several Application levels, a User Interface/Dashboard level, an Integration Services Level and a Data Source Level.

As shown, the Application level contain standard native applications, namely, Application A, Application B as well as Other Applications. The User Interface/Dashboard Level contain the user interface. The Integration Services level contain the requisite integration components, such as the integration engine and service adapters. Finally, the Data Source Level contains the various data stores that are created, managed and stored for the purposes of synchronizing data across applications.

Referring back to the figures, FIG. 12 depicts how a user, using a standard application (in this case, Application A), creates a client record for a new person/client/customer/prospect in accordance with the present invention. As evidenced by the illustrated flow, there is no interaction with any of the integration components of the system, that is the Dashboard or the Integration Services, during this process. Because of this, the integration components are unaware of the new client record. This situation would be accounted for in future work-flows by either the user or by the integration software.

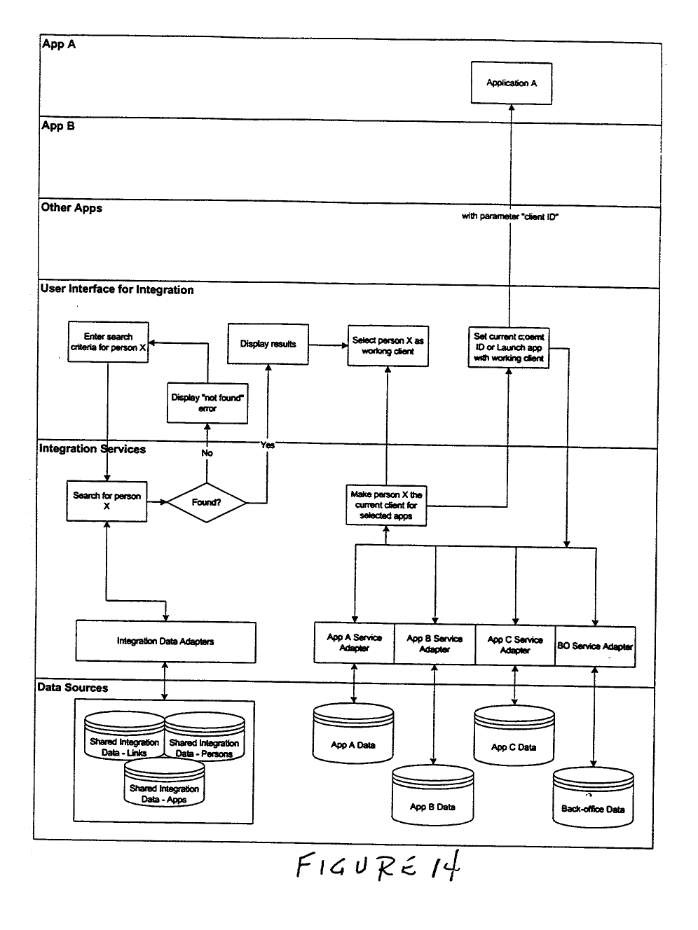

Alternatively, FIG. 13 depicts how a user, using the Dashboard, creates a client record for a new person/client/customer/prospect in accordance with the present invention.

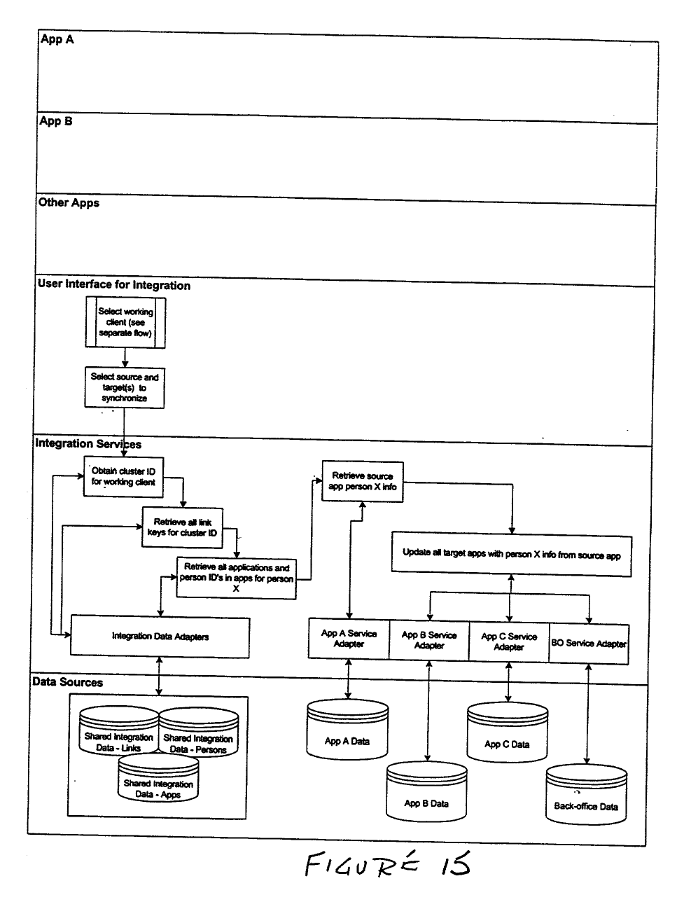

FIG. 14 depicts how a user, selects a Working Client using the Dashboard, in accordance with the present invention. This integration flow assumes that the selected Working Client already exists in the Link Table.

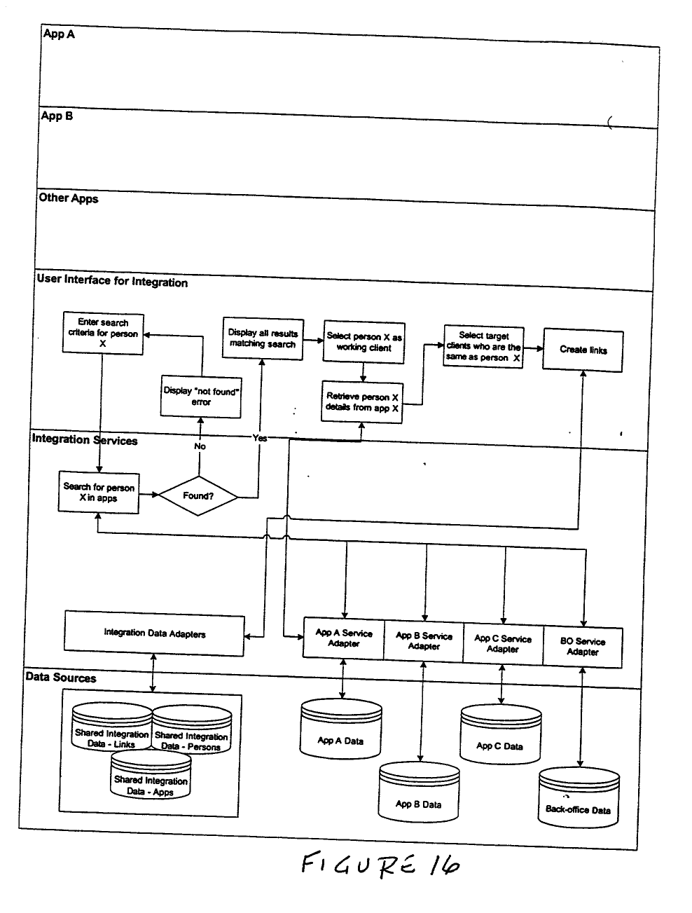

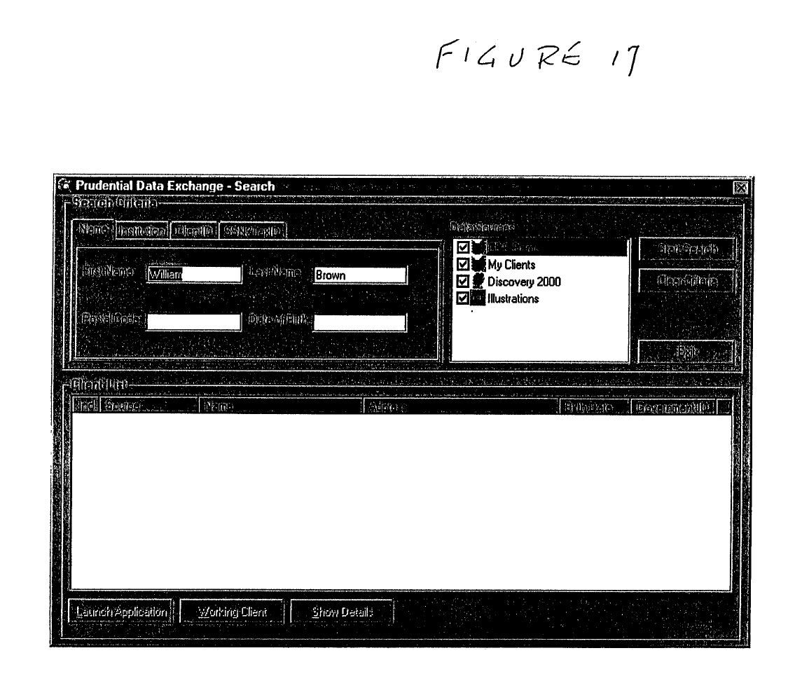

The flow of FIG. 15 depicts synchronization of a linked client and FIG. 16 depicts how links between applications are established.

### PRACTICAL APPLICATIONS

The following sections provide practical applications of the present solution in order to fully appreciate features of the present solution.

In the use cases that follow, Agent Ms. Angie Baker will begin her workflow by prospecting for a potential customer, a Mr. William R. Brown. Among the various integrated applications on Ms. Baker's Dashboard include: a prospecting, a discovery, an analysis application, an asset allocation application, a product illustrations application and an electronic assistant application. For simplicity, the foregoing applications shall hereinafter be referred to as a CDS application, a DIS application, a PAS application, a PLAM application, an ISP application and EA application, respectively. Ms. Baker's Dashboard also includes one or two external, non-integrated applications, for example, a web browser application such as Microsoft® Internet Explorer®.

Use Case 1: Creating a New Person and Pushing Information into a Second Application

This use case can take place over a period of several days or weeks. After prospecting with the CDS application, Ms. Baker meets with a potential customer or prospect, a Mr. William R. Brown, and gathers information about Mr. Brown using the Discovery application. Ms. Baker further analyzes the prospects information using the PAS application.

To propose insurance policies to the prospect, Ms. Baker moves on to ISP to create illustrations of the products for the prospect. When the prospect chooses an insurance policy and chooses to open an investment account, Ms. Baker uses the PLAM application to capture required investor information. Finally, Ms. Baker uses the EA application to submit the new business information.

After many days of calling Mr. Brown for a follow-up meeting, Ms. Baker finally sets up an appointment with Mr. Brown. Ms. Baker meets with Mr. Brown and gathers information about Mr. Brown and completes a paper-based Fact Finder on Mr. Brown during the meeting. Ms. Baker returns to her office to enter the Fact Finder data into the Discovery application.

To begin entering the Fact Finder data into the Discover application, Ms. Baker clicks on the “Search” button of the Dashboard.

The search dialog appears and Ms. Baker enters the name search criteria, such as “Brown” in the last name field and “William” in the first name field, selects the Source applications she wants to search (e.g. CDS, ISP), and clicks on the “Search” button. After Ms. Baker submits the search request, the results appear as a list of William Brown's found in the selected applications.

Ms. Baker highlights the William Brown she wants to work with (from the CDS application database in this case since she first entered Mr. Brown's information in the CDS application) based on the information displayed (such as address and Tax ID) and clicks on the “Working Client” button, thereby setting William R. Brown as the current client. The “Working Client: William R. Brown (CDS:)” is then set and indicated in the Status area of the Dashboard. Note: the term “Working Client” refers to both customers and prospects.

Ms. Baker then clicks on “PAS/Discovery” button. A dialog box opens asking “This action will create information about the Working Client in PAS/Discovery. Do you want to continue?” Ms. Baker sees a “Yes” button, a “No” button, and a check box titled “Don't ask anymore. Just do it.” Ms. Baker has become familiar with the Dashboard interface and checks the “Don't ask” check box. If William R. Brown records were already in the PAS/Discovery applications, the dialog box would have said “This action will update existing information about the working client in PAS/Discovery. Do you want to continue?” The existence of William R. Brown in the PAS/Discovery applications is based on information in the Link Table and therefore a search of the PAS/Discovery database(s) is not done.

The Integration Engine pulls William R. Brown's information from the CDS application's database and pushes it into the PAS application's database and then launches the Discovery application to displays the newly created William R. Brown record in the Discovery application. Ms. Baker then enters the information from the Fact Finder into the Discovery application for use in the PAS application.

When Ms. Baker is done entering the information from the Fact Finder into the Discovery application and because it is the end of the day on Friday, Ms. Baker shuts down her computer and heads home for the weekend.

Use Case 2: Pushing Person Information from One Source Application into Another Destination Application

On the following Monday, Ms. Baker is scheduled to meet with Mr. Brown for an implementation meeting. During this meeting she will use the ISP application. To save time and eliminate re-keying of data, client specific information from the CDS application will be pushed into the ISP application.

In preparation for the meeting with Mr. Brown, Ms. Baker turns on her computer, which automatically launches the Dashboard. The Working Client is set to Mr. Brown and the Working/Source Application is still set to the CDS Application as evidenced by the caption “Working Client: William R. Brown (CDS:)” in the Status area of the Dashboard.

Ms. Baker then clicks on the “ISP” application button on the Dashboard to push information about Mr. Brown from the CDS application into the ISP application. Note: since Ms. Baker previously checked the “Don't ask” check box, no dialog box appears. Thereafter, the ISP application automatically launches and displays Mr. Brown's record.

Use Case 3: Pushing Client Specific Information from One Source Application into More Than One Destination Application

The next day, Ms. Baker must use both the PLAM and the EA applications because she successfully sold an insurance policy and an investment account to Mr. Brown. Rather than following an application-by-application workflow, she decides (as a sophisticated user) to populate these applications at the same time with Mr. Brown's information.

Hence, Ms. Baker turns on her computer, which automatically launches the Dashboard. Again, the Working Client is set to Mr. Brown and the Working/Source Application is set to the CDS Application as evidenced by the caption “Working Client: William R. Brown (CDS)” in the Status area of the Dashboard.

Using the Dashboard, Ms. Baker clicks on the “Search” button, launching the Search applet. The applet forms are automatically populated with information from the Working Client. Ms. Baker selects the PLAM and EA applications and then clicks on the “Synchronize” button to push Mr. Brown's information from the CDS application to the PLAM and EA applications

After synchronization is complete, Ms. Baker clicks on the “EA” button, which launches the EA application and displays Mr. Brown's record created in the EA application as a result of the “Synchronize” action. After completing the EA application, Ms. Baker launches the PLAM application through the Dashboard in the same manner.

Use Case 4: Searching for a Person

After taking an extended leave of absence from work, Ms. Baker cannot recall who she previously worked on and entered into the various applications.

Furthermore, during her leave her assistant Ms. Green worked on several cases, which Ms. Baker is unaware of.

To get up to speed, Ms. Baker turns on her computer, which automatically launches the Dashboard. However, the Working Client is no longer set to Mr. Brown but to a different client.

When Ms. Baker receives calls from unfamiliar people, she clicks on the “Search” button on the Dashboard and uses the name search function. She can then launch into each application from the list of people displayed in the results area of the search window by double-clicking on a person's row or by highlighting the person and clicking on the “Launch Application” button. Using this method, she can get background information on each person she has searched.

Use Case 5: Synchronizing Information

Later that day, Ms. Baker realizes that while she had linked Mr. William R. Brown together, his address information is not the same across all of the applications.

Thus, Ms. Baker brings up all occurrences of William R. Brown using the Dashboard “Search” button. All of the same William Brown rows are highlighted. She realizes that she missed an occurrence of William R. Brown in another application. She highlights that row as well and then clicks on the “Synchronize” button.

Ms. Baker confirms that the freshest information is in the CDS application. She knows that the currently highlighted row in the results list will be used as the source of the freshest information. By default, the currently highlighted row is the “Working Client” row. She recognizes the currently highlighted row because it is highlighted differently from the others. The other occurrences of Mr. Brown will be updated with the information from the CDS application.

After synchronization, the search result list is refreshed with the updated information.

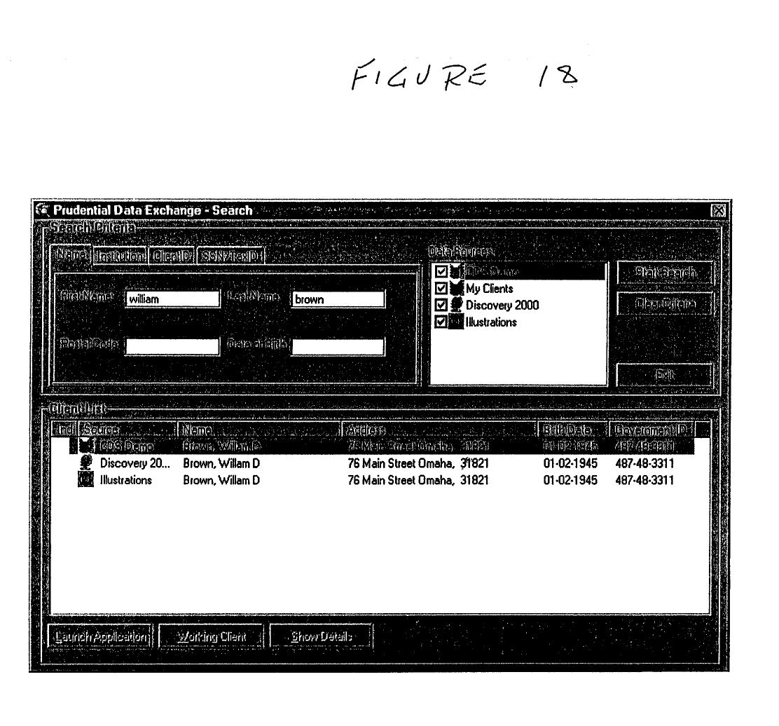

Finally, FIGS. 17-22 are representations of user interface screens depicting aspects of the present invention described hereinabove.

### CONCLUSION

Having now described a preferred embodiment of the invention, it should be apparent to those skilled in the art that the foregoing is illustrative only and not limiting, having been presented by way of example only. All the features disclosed in this specification (including any accompanying claims, abstract, and drawings) may be replaced by alternative features serving the same purpose, and equivalents or similar purpose, unless expressly stated otherwise. Therefore, numerous other embodiments of the modifications thereof are contemplated as falling within the scope of the present invention as defined by the appended claims and equivalents thereto.

Moreover, the techniques may be implemented in hardware or software, or a combination of the two. Preferably, the techniques are implemented in computer programs executing on programmable computers that each include a processor, a storage medium readable by the processor (including volatile and non-volatile memory and/or storage elements), at least one input device and one or more output devices. Program code is applied to data entered using the input device to perform the functions described and to generate output information. The output information is applied to one or more output devices.

Each program is preferably implemented in a high level procedural or object oriented programming language to communicate with a computer system, however, the programs can be implemented in assembly or machine language, if desired. In any case, the language may be a compiled or interpreted language.

Each such computer program is preferably stored on a storage medium or device (e.g., CD-ROM, hard disk or magnetic diskette) that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A system for synchronizing data between applications having respective data stores, said system comprising:
two or more application service adapters associated with said application data stores;
a links table for managing shared integration data;
an integration engine having associated therewith an integration engine service adapter and an integration engine data store; said integration engine to use said links table to manage the flow of information among all said data stores.
